(19) United States
(12) Patent Application Publication
(10) Pub. No.: US 2015/0077772 A1
(43) Pub. Date: Mar. 19, 2015

(54) DATA GENERATION APPARATUS, NON-TRANSITORY COMPUTER-READABLE STORAGE MEDIUM, AND DATA GENERATION METHOD

(71) Applicant: KONICA MINOLTA, INC., Chiyoda-ku (JP)

(72) Inventors: Kunikazu SATOU, Tama-shi (JP); Masahiro Ozawa, Hino-shi (JP); Takahisa Matsunaga, Hino-shi (JP); Mitsuharu Hayasaka, Suginami-ku (JP); Hiroshi Nogawa, Hachioji-shi (JP); Yasufumi Aoyama, Hachioji-shi (JP); Tetsuren Ri, Hachioji-shi (JP)

(73) Assignee: KONICA MINOLTA, INC., Tokyo (JP)

(21) Appl. No.: 14/483,418

(22) Filed: Sep. 11, 2014

(30) Foreign Application Priority Data
Sep. 18, 2013 (JP) 2013-192892

(51) Int. Cl. G06F 3/12; G06K 15/02; G06K 15/00

(52) U.S. Cl. CPC G06F 3/1256; G06K 15/005; G06K 15/1878; H04N 2201/0094
USPC 358/1.9; 358/1.15; 358/1.11

(57) ABSTRACT

A data generation apparatus includes: a communication section configured to communicate with a print instructing apparatus; and a preview-image generating section configured to analyze a received print job and generate a preview image. The preview-image generating section is further configured to determine whether or not an object having a property not supported by the data generation apparatus exists in each page of the document; in response to determining that the object exists, obtain a possible alternative to the property of the object; generate edit data to be used for highlighting a replaced part in the preview image in which the property of the object is replaced with the possible alternative; and output the edit data to the print instructing apparatus so as to allow a user to recognize the replaced part.

This application is based on Japanese Patent Application No. 2013-192892 filed on Sep. 18, 2013, in the Japan Patent Office, the entire content of which is hereby incorporated by reference.

### TECHNICAL FIELD

The present invention relates to a data generation apparatus, a non-transitory computer-readable storage medium storing a data generation program, and a data generation method. In particular, the present invention relates to a data generation apparatus, a non-transitory computer-readable storage medium storing a data generation program, and a data generation method that generate print preview data.

### BACKGROUND

Many printers of late years have preview functions. Such printers are configured to, before printing a document, display a preview image that shows an appearance of a print output and to allow a user to confirm the displayed print preview image, so as to prevent output of unwanted printouts. Also in the case that a user instructs such a printer to conduct printing through a printer driver working in a user terminal, the printer causes the user terminal to display a preview image, so as to prevent output of unwanted printouts. Moreover, in recent years, there has been used a method of employing a Web application provided by a Web server and of displaying a preview display image created by the Web server onto a Web screen of a user terminal. Such preview display allows users, before printing, to confirm, for example, drawing positions, drawing sizes, drawing misalignment, and print splitting, and especially nowadays further allows to users to confirm positions of punching or stapling, which provides very convenient features for users.

With respect to techniques related to the preview display, for example, Japanese Patent Application Laid-Open Publication (JP-A) No. 2010-79766 discloses a document printing system having a printer driver that converts print information created by an application into print data that can be interpreted by a printing device, wherein the system includes: a print preview section for displaying a preview screen showing a print image of the print information before transmitting the print information to the printing device; an edit section for additionally editing the print image on the preview screen; and a print data generation section for generating print data that can be interpreted by the printing device based on the print information and the edit data for the additional editing.

In addition, JP No. 2011-39898 discloses an image forming apparatus that can communicate data with at least one printing device via a network, wherein the apparatus includes: a print job acquisition section for acquiring a print job based on a print instruction given by a user; an image forming section for performing print output by executing the print job; an event detection section for detecting an occurrence of a predetermined event; and a print preview processing section which, when the occurrence of the predetermined event is detected by the event detection means, acquires a first print preview image of a case when the print job is executed in the image forming section, and a second print preview image of a case when the print job is executed in the printing device, and outputs the first print preview image and the second print preview image.

Although a printing device with a preview function generates a print preview image to be used for preview display based on a print job for a document, there are cases where the document includes a font not supported by the printing device, or the document has been created using a function not supported by the printing device (e.g., 3D drawing function). In such cases, the printing device generates a print preview image by replacing a font or a function not supported by the apparatus with an alternative font or an alternative function supported by the apparatus. Accordingly, the replacing result is reflected in the print preview image transmitted from the printing device to the user terminal at the host side. Since information about the replacement of the font or function was not presented to a user at that time in conventional technologies, there was a problem that the user cannot recognize what part in the document has been replaced and how it has been replaced just by looking into the print preview image and that the user hardly determine appropriately whether or not to execute the print processing.

Especially in recent years, situations that users give print instructions using mobile devices, such as a tablet device and a smart phone, are increasing as mobile devices have become popular. However, since screens on mobile devices are small, it becomes more difficult for users to recognize what part in the document has been replaced and how it has been replaced. In addition, occurrence of the above problems is not limited to the preview display for printing. Rather, they similarly occurs in preview display used for transmitting a document via facsimile, for example. The present invention seeks to solve those problems.

### SUMMARY

There are disclosed illustrative data generation apparatuses, non-transitory computer-readable storage media each storing a data generation program, and data generation methods.

An illustrative data generation apparatus reflecting one aspect of the present invention is a data generation apparatus comprising: a communication section configured to communicate with a print instructing apparatus which can output a print job of a document; and a preview-image generating section configured to analyze a print job received by the communication section and generate a preview image showing each page of the document, where the each page reflects print settings. The preview-image generating section is further configured to determine whether or not an object having a property not supported by the data generation apparatus exists in each page of the document; and, in response to determining that the object exists, obtain at least one possible alternative to the property of the object, where each of the least one possible alternative is supported by the data generation apparatus. The preview-image generating section is further configured to generate edit data to be used for highlighting a replaced part in the preview image in which the property of the object is replaced with the at least one possible alternative at the replaced part, and output the edit data to the print instructing apparatus so as to allow a user to recognize the replaced part.

A non-transitory computer-readable medium reflecting one aspect of the present invention stores a data generation program to be executed in a processing apparatus communicably connected with a print instructing apparatus which can output a print job of a document. The data generation program, when being executed by a processor of the processing apparatus, causes the processor to perform processes comprising: analyzing the print job; and generating a preview image showing each page of the document, where the each page reflects print settings. The analyzing the print job includes determining whether or not an object having a property not supported by the processing apparatus exists in each page of the document; and in response to determining that the object exists, obtaining at least one possible alternative to the property of the object, where each of the least one possible alternative is supported by the processing apparatus. The generating the preview image includes generating edit data to be used for highlighting a replaced part in the preview image in which the property of the object is replaced with the at least one possible alternative at the replaced part; and outputting the edit data to the print instructing apparatus so as to allow a user to recognize the replaced part.

A data generation method of a printing system including a print instructing apparatus which can output a print job of a document and a processing apparatus which can process the print job, where the print instructing apparatus and the processing apparatus are connected through a communication network. The data generation method comprises: sending a print job from the print instructing apparatus to the processing apparatus; receiving and analyzing the print job by the processing apparatus; generating a preview image showing each page of the document, by the processing apparatus, where the each page reflects print settings; and displaying the preview image by the print instructing apparatus. The analyzing the print job includes determining, by the processing apparatus, whether or not an object having a property not supported by the processing apparatus exists in each page of the document; and in response to determining that the object exists, obtaining, by the processing apparatus, at least one possible alternative to the property of the object, where each of the least one possible alternative is supported by the processing apparatus. The generating the preview image includes generating, by the processing apparatus, edit data to be used for highlighting a replaced part in the preview image in which the property of the object is replaced with the at least one possible alternative at the replaced part; and outputting the edit data from the processing apparatus to the print instructing apparatus. The displaying the preview image includes displaying the preview image by the print instructing apparatus by using the edit data so as to allow a user to recognize the replaced part.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a diagram schematically illustrating a construction of a printing system according to an embodiment of the present invention;

FIG. 2 is a block diagram illustrating a construction of a printer (or a server) included in a printing system according to an embodiment of the present invention;

FIG. 3 is a block diagram illustrating a construction of a computing device (or mobile device) included in a printing system according to an embodiment of the present invention;

FIG. 4 is a flowchart illustrating operations (processes until transmission of a print job) of a computing device according to an embodiment of the present invention;

FIG. 5 is a flowchart illustrating operations (processes until display of a preview image) of a computing device according to an embodiment of the present invention;

FIG. 6 is a diagram illustrating an example of a document created with a computing device according to an embodiment of the present invention;

FIG. 7 is a diagram illustrating a display example (example that the part of alternative font is emphasized) of preview displaying data created with a printer according to an embodiment of the present invention;

FIG. 8 is a diagram illustrating a display example (example that the part of alternative function is emphasized) of preview displaying data created with a printer according to an embodiment of the present invention;

FIG. 9 is a flowchart illustrating operations of a printer according to an embodiment of the present invention;

FIGS. 10A and 10B are diagrams of a flowchart illustrating operations (analysis processing) of a printer according to an embodiment of the present invention; and

FIG. 11 is a flowchart illustrating operations (drawing processing) of a printer according to an embodiment of the present invention.

### DETAILED DESCRIPTION

Illustrative embodiments of data generation apparatuses, non-transitory computer-readable storage media each storing a data generation program, and data generation methods will be described with reference to the drawings. It will be appreciated by those of ordinary skill in the art that the description given herein with respect to those figures is for exemplary purposes only and is not intended in any way to limit the scope of potential embodiments may be resolved by referring to the appended claims.

According to illustrative data generation apparatuses, non-transitory computer-readable storage media each storing a data generation program, and data generation methods as embodiments of the present invention, it is possible to generate data for preview display which allows a user to easily recognize a replaced part in the preview display.

This is because the data generation apparatus (by executing a data generation program thereon) analyzes a print job and generate a preview image showing each page of a document, where the each page reflects print settings which have been established. In this processing, the data generation apparatus determines whether or not there is an object having a property not supported by the apparatus in a page; obtains, if there is such an object, a possible alternative supported by the apparatus as an alternative to the property of the above object; and generates edit data to be used for highlighting the replaced part (displaying with emphasis the replaced part) in a preview image in which the property of the object is replaced with the alternative at the replaced part. In addition, it is also because the data generation apparatus generates data of possible alternatives to be used for displaying the obtained possible alternatives so as to allow a user to designate any of them.

As described in the descriptions of the background, confirmation of an appearance of a print output by using a print preview image is popularly carried out in order to avoid output of unwanted printouts. The print preview image is an image showing an appearance of a print output obtained when a document created with a computing device is outputted by a printer. However, there are cases where the printer does not support a font in the document created using the computing device, or cases where the printer does not support a function (e.g., 3D drawing function) of an application in the computing device, for example.

In such cases, the printer creates a print preview image by, for example, replacing the font in the document with another font supported by the printer, or replacing the function of the application with a function supported by the printer. That is, when a document is created using a font or a function that are not supported by the printer, it makes a mismatch between a document created using the computing device and a document outputted using the printer.

Therefore, it is necessary to confirm which part has been replaced and how the part has been replaced in the document when the font or the function has been replaced. In a conventional printing system, the print preview image was created by automatically replacing unsupported fonts or unsupported functions with corresponding alternatives. Accordingly, it was difficult for a user to recognize which part has been changed and how the part has been changed in a computing device that displays print preview images, especially in a mobile device having a small screen, and thus there was a problem that it is not possible for the user to determine whether to print the document or not appropriately. In addition to preview display in the case of printing, there were similar problems in, for example, preview display in facsimile transmission.

Accordingly, one embodiment of the present invention provides a technology to, when a font or a function not supported by a printer in a preview image is replaced with an alternative font or an alternative function supported by the printer, highlight the replaced part (display the replaced part with emphasis) in the preview image. In addition, other possible alternatives may be displayed so as to allow a user to designate any of them. Thereby, the user can recognize the replaced part easily, and thus it is possible for the user to determine appropriately whether or not the printing job should be executed just by looking into the preview image. Further, when the technology employs displaying other possible alternatives so as to allow a user to designate any of them, a user can change the part to be replaced by using the alternative desired by the user, and thus it is possible for the user to determine more appropriately whether or not the printing job should be executed just by looking into the preview image.

### Examples

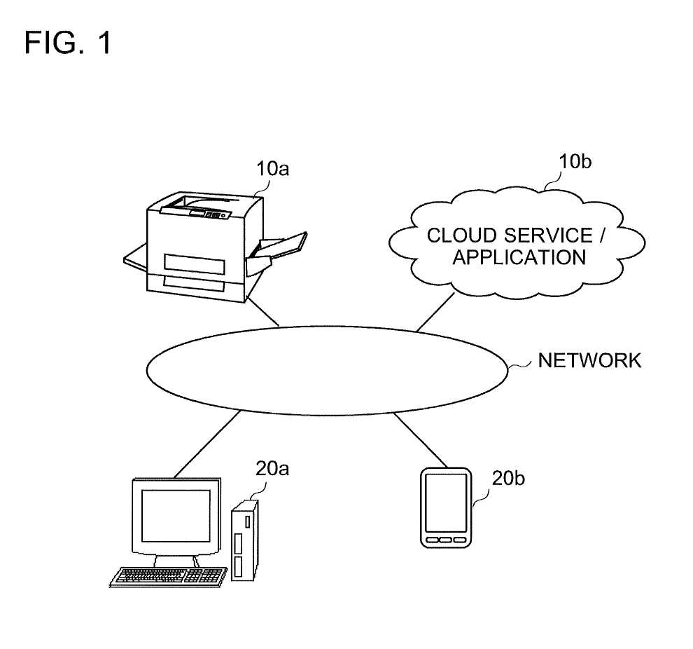

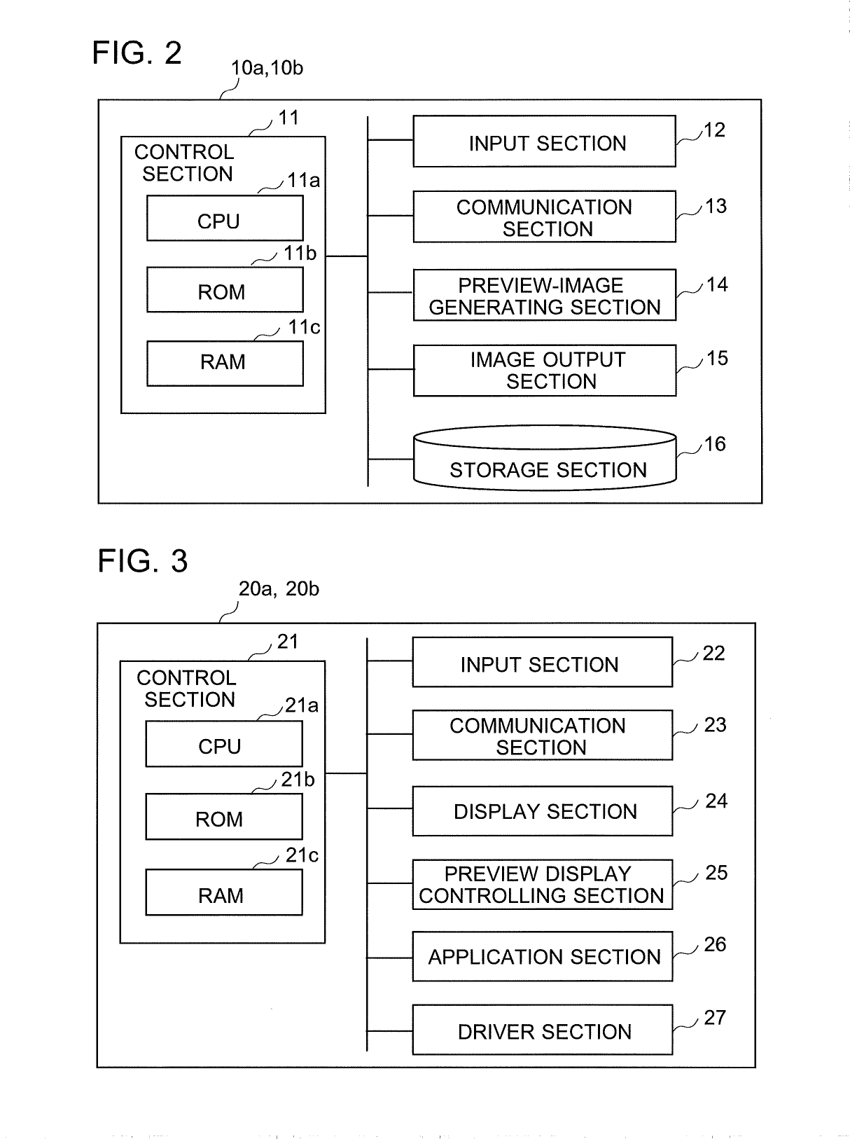

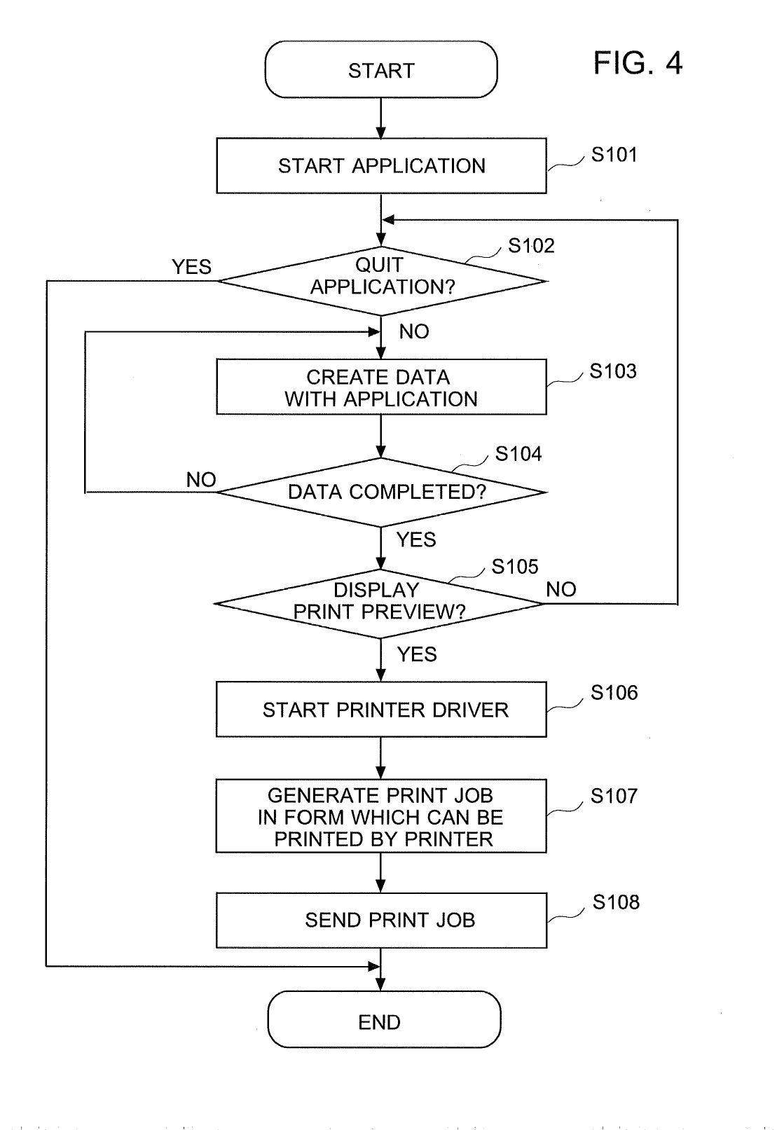

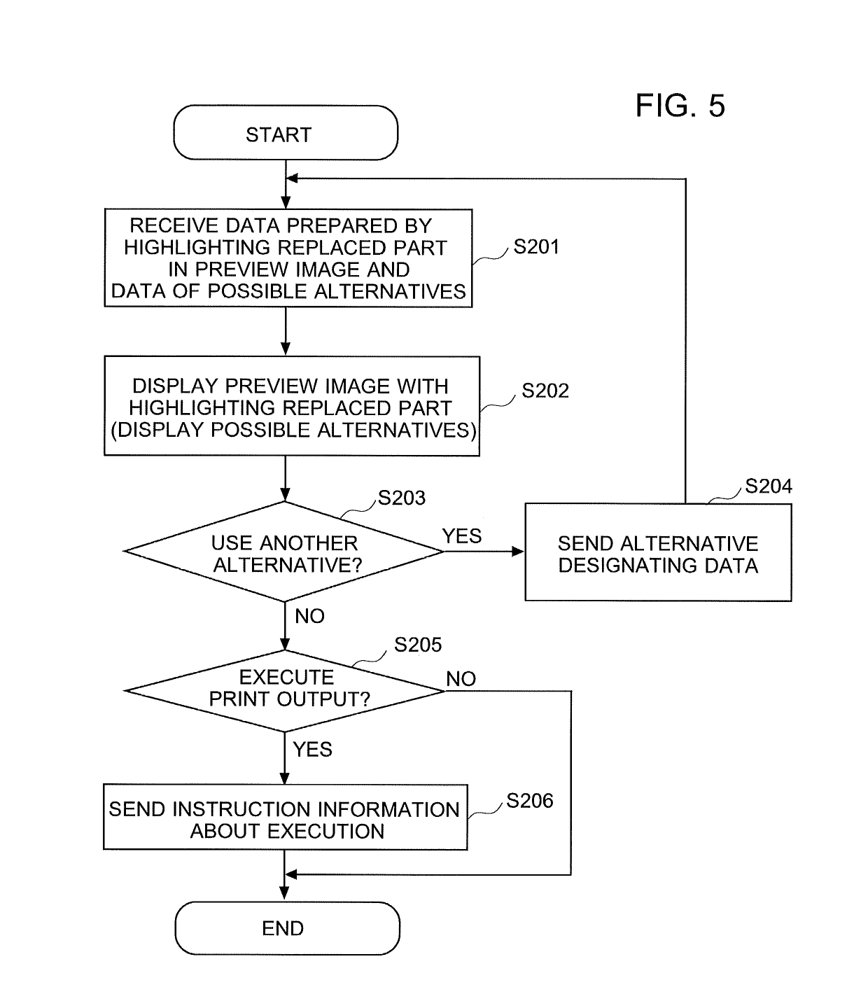

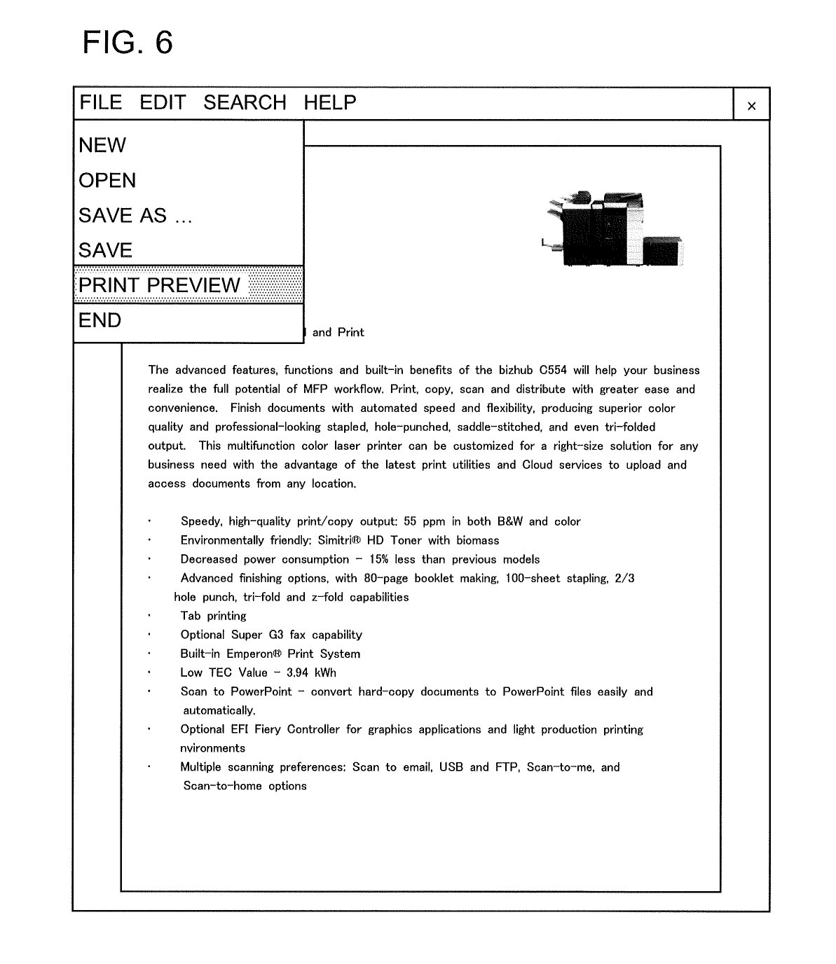

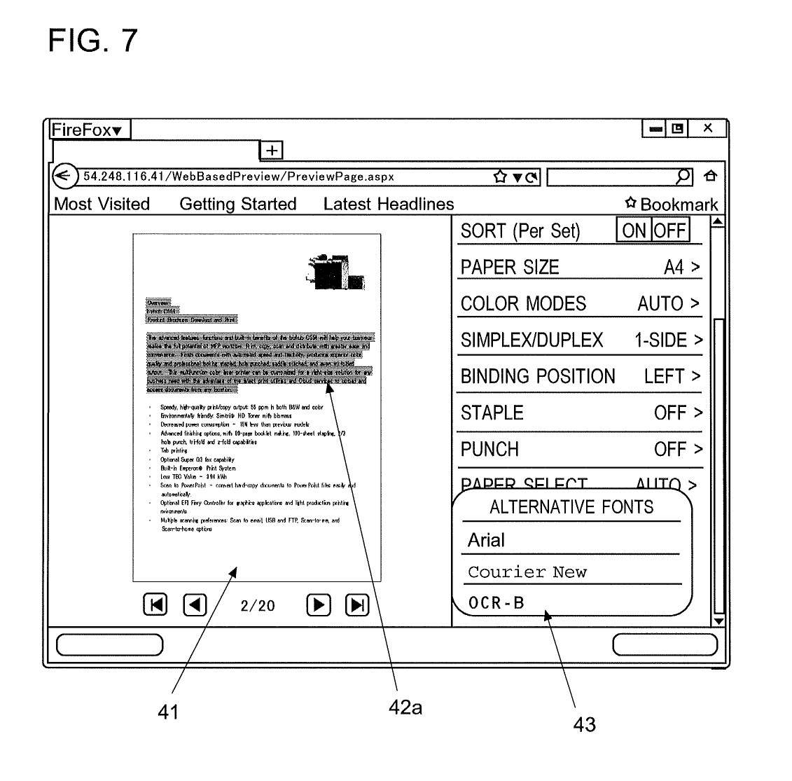

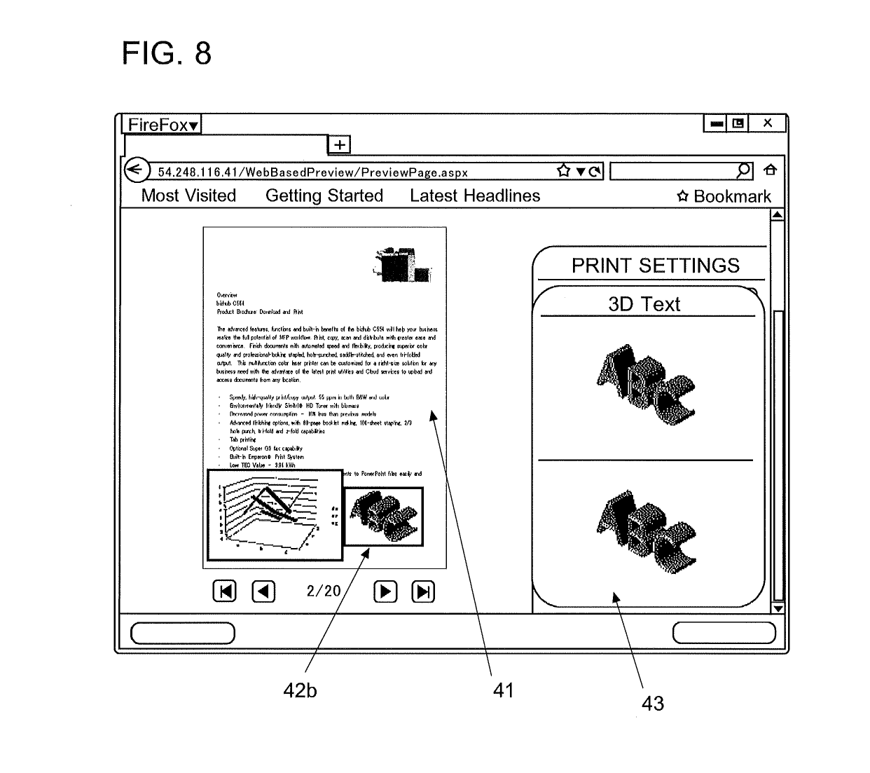

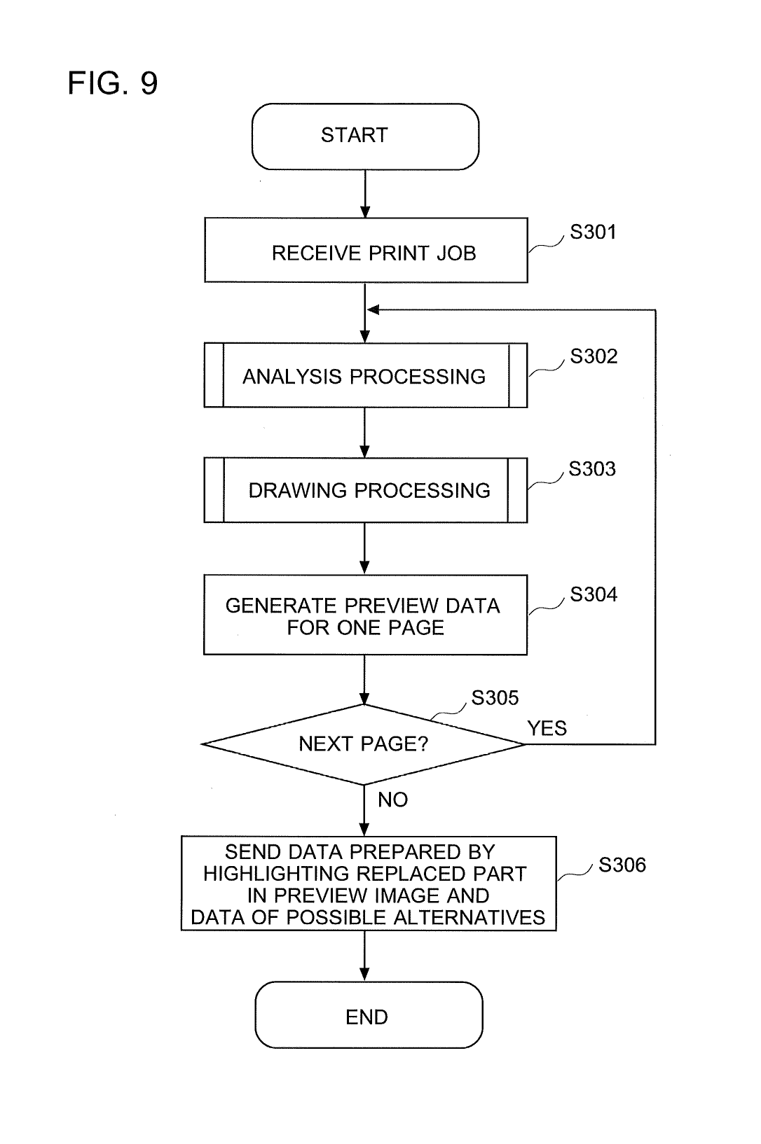

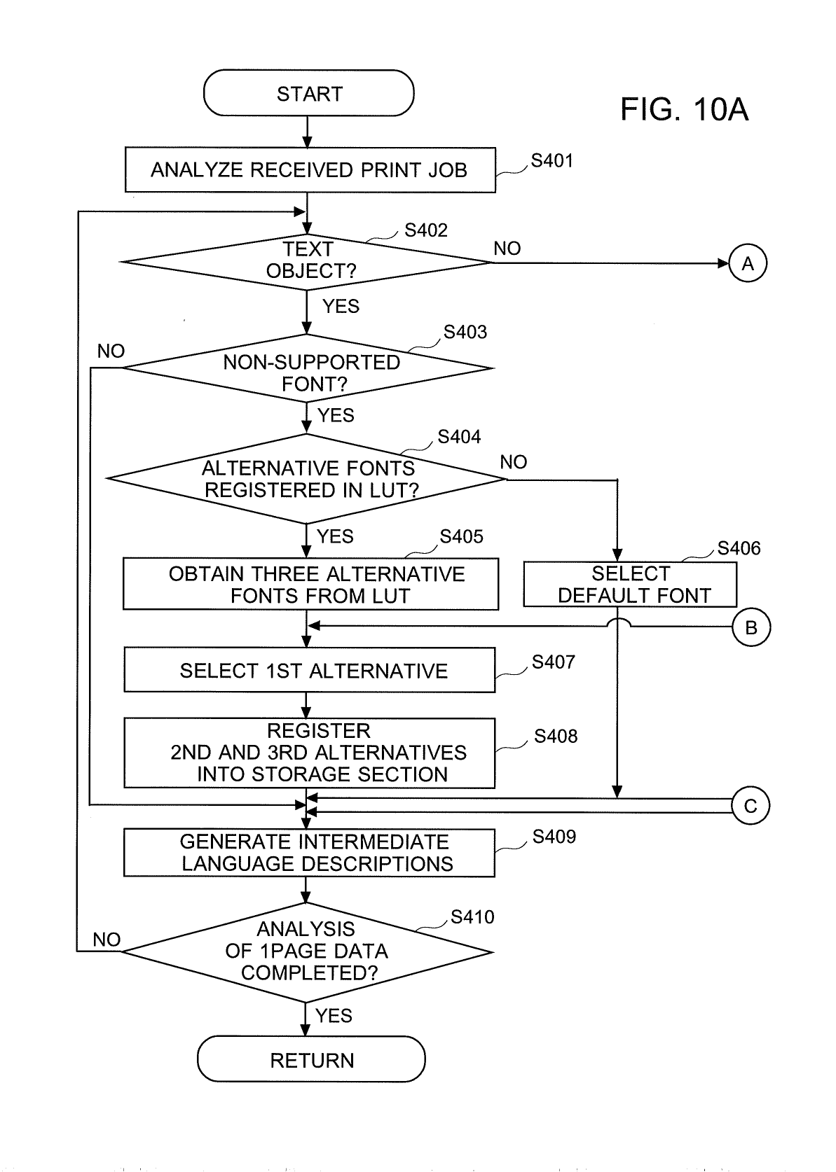

In order to describe the embodiments of the present invention in detail, a data generation apparatus, a non-transitory computer-readable storage medium storing a data generation program, and a data generation method according to the present example will be described with reference to FIGS. 1 to 11. FIG. 1 is a diagram schematically illustrating a construction of the printing system according to the present example; FIG. 2 is a block diagram illustrating a construction of a printer (or server); and FIG. 3 is a block diagram illustrating a construction of a computing device (or mobile device). In addition, FIG. 4 and FIG. 5 are flowcharts illustrating operations of the computing device; and FIG. 6 is a diagram illustrating an example of a document created using the computing device. In addition, FIG. 7 and FIG. 8 illustrate display examples of print preview data created using the printer according to the present example; and FIGS. 9 to 11 are flowcharts illustrating operations of the printer according to the present example.

It should be noted that, in the present example, a preview image is an image of each page in a document, wherein the each page reflects print settings which have been established for printing the document. The preview image corresponds to an image to be actually printed. When a font or a function not supported by the printing apparatus is used in the document, the font or the function is replaced with the corresponding alternative in the preview image. In addition, edit data is data to be used for highlighting (displaying with emphasis) the replaced part, where the font or the function is replaced, in the preview image. The edit data may be data of an image prepared by editing the preview image with highlighting (emphasizing) the replaced part, or partial data to be used for editing the preview image such that the replaced part is highlighted (displayed with emphasis) (e.g., data for superimposing onto the replaced part in the preview image, and data for overwriting onto the replaced part in the preview image). The former edit data is used in the following descriptions about the present example.

As illustrated in FIG. 1, the printing system according to the present example includes: a device at a side where data for preview display (preview displaying data) is generated; and a device at a side where the preview displaying data is displayed. The device at a side where preview displaying data is generated can be, for example, a device including a print engine, such as a printer and an MFP (herein referred to as a printer 10a), and/or a device not including a print engine (only image processing is executed), such as a server for providing cloud services and applications for preview display (herein referred to as a server 10b). In addition, the device at a side where preview displaying data is displayed can be: a computing device 20a, such as a personal computer; and/or a mobile device 20b, such as a smart phone and a tablet device. Further, the computing device 20a and a mobile device 20b can work as a print instructing apparatus which can output a print job of a document. The devices at a side where preview displaying data is generated and devices at a side where the preview displaying data is displayed are connected with each other via a network, such as LAN (Local Area Network) and WAN (Wide Area Network), defined according to standards, such as Ethernet (registered trademark), token ring, and FDDI (Fiber-Distributed Data Interface).

In FIG. 1, the printer 10a and the server 10b are illustrated as devices at a side where preview displaying data is generated, and the computing device 20a and the mobile device 20b are illustrated as devices at a side where preview displaying data is displayed. However, the system may be made by freely combining at least one of the printer 10a and the server 10b, and at least one of the computing device 20a and the mobile device 20b. In addition, in FIG. 1, the device at a side where preview displaying data is generated and the device at a side where preview displaying data is displayed are connected via a network, such as LAN and WAN. However, the printer 10a and the computing device 20a may be arranged to be connected by a USB (Universal Serial Bus) cable, for example. Hereafter, each device will be described in detail. Printer 10a (Server 10b):

FIG. 2 illustrates a construction of the printer 10a and the server 10b as the devices at a side where preview displaying data is generated. In the present example, descriptions will be given with exemplifying the construction of each of the printer 10a and the server 10b. The printer 10a mainly includes a control section 11, an input section 12, a communication section 13, a preview-image generating section 14, an image output section 15, and a storage section 16, for example. In addition, the server 10b mainly includes a control section 11, an input section 12, a communication section 13, a preview-image generating section 14, and a storage section 16.

The control section 11 includes: a CPU (Central Processing Unit) 11a; and a memory, such as a RAM (Random Access Memory) 11c, which serves as a workspace, and a ROM (Read Only Memory) 11b, which serves as a storage region for a control program. The CPU 11a controls various functions of the printer 10a (or server 10b) by reading a program from the ROM 11b or the storage section 16, and developing and executing the program on the RAM 11c.

The input section 12 is, for example, a touch panel or a hard key and receives various operations related to printing and operations of registering LUT described later, for example.

The communication section 13 includes, for example, an NIC (Network Interface Card) and a modem, and establishes communication with the computing device 20a or the mobile device 20b via the network. The communication section 13 receives, for example, a print job for instructing printing of a document, and alternative designating data which designates, for example, an alternative font and/or an alternative function, from the computing device 20a or the mobile device 20b. In addition, the communication section 13 transmits, for example, edit data (data to be used for highlighting the replaced part in the preview image) generated by the preview-image generating section 14, and data of possible alternatives to the computing device 20a or the mobile device 20b.

The preview-image generating section 14 generates a preview image of a document based on a print job, that is, a preview image according to an appearance of a print output of the received document. Specifically, the preview-image generating section 14 performs, for example, analysis processing which analyzes the print job received from the computing device 20a or the mobile device 20b for each page and generates intermediate language, and drawing processing which creates frame data by rasterizing the intermediate language for every frame and generates a bitmap image for one page for previewing based on the frame data.

In the analysis processing, the preview-image generating section 14 determines whether or not there is an object having a font, a function, or the like (these are generically called a property) not supported by the printer 10a or the server 10b in a page of the document. When determining that such an object exists, the preview-image generating section 14 refers a pre-stored table (LUT) and obtains a possible alternative (alternative font of alternative function) to the property of the object, where the possible alternative is a property supported by the printer 10a or the server 10b and is selected as such that the result of drawing the page by using the possible alternative is close to the appearance of the page displayed on the computing device 20a or the mobile device 20b. In addition, in the above-described drawing processing, the preview-image generating section 14 generates the preview image by replacing the object with the possible alternative, and generates edit data for changing color of the object, changing color of the background of the object, adding a frame enclosing the object, or changing thickness of characters in the object so as to highlight the replaced part in the preview image. Further, the preview-image generating section 14 outputs the edit data to the computing device 20a or the mobile device 20b so as to allow a user to recognize the replaced part in the preview image, on the computing device 20a or the mobile device 20b.

The image output section 15 is an engine arranged in the printer 10a and prints an image of a document on sheets of paper according to an instruction from the control section 11. Specifically, the image output section 15 includes elements required for image formation that uses image formation processes, such as an electrophotography technique and an electrostatic recording technique. Examples of those elements include an electrification device, a photoconductor drum, an exposure device, a transfer roller, a transfer belt, and a fixing device. Specifically, the image output section 15 performs processing that forms an electrostatic latent image by irradiating light corresponding to the image data from the exposure device onto the photoconductor drum electrified by the electrification device, develops using a developer device by adhering on the toner, transfers the toner image onto the paper medium via a primarily transferring roller and a secondary transfer belt, and fixes the toner image by a fixing device.

The storage section 16 includes an HDD (Hard Disk Drive), an SSD (Solid State Drive), or the like, and stores a print job, data of a preview image, edit data for a preview image, data of possible alternatives, and an LUT to be used for obtaining possible alternatives, for example.

It should be noted that, although FIG. 2 has an arrangement in which the preview-image generating section 14 executes the analysis processing and the drawing processing, the control section 11 may be arranged to execute the analysis processing and the drawing processing with a data generation program when the data generation program is executed by the CPU 11a.

Computing Device 20a (Mobile Device 20b):

The computing device 20a and the mobile device 20b mainly include a control section 21, an input section 22, a communication section 23, a display section 24, a preview display controlling section 25, an application section 26, and a driver section 27, for example.

The control section 21 includes: a CPU 21a; and a memory, such as a RAM 21c which serves as a workspace, and a ROM 21b, which serves as a storage region for programs for the operation system. The CPU 21a and the memory are connected via a bus. The CPU 21a controls various functions of the computing device 20a (or mobile device 20b) by reading programs from the ROM 21b, and developing and executing the program on the RAM 21c.

The input section 22 receives, for example, operations upon creating a document using the application section 26, operations upon creating a print job that is to be transmitted to the printer 10a (or server 10b) using the driver section 27, and operations that selects possible alternatives in the preview screen displayed on the display section 24.

The communication section 23 includes an NIC, a modem, or the like, and establishes communications with the printer 10a or the server 10b via a network. The communication section 23 transmits to the printer 10a or the server 10b, for example, a print job and alternative designating data which designates the selected possible alternative, and receives from the printer 10a or the server 10b, for example, the preview image edit data and data of possible alternatives.

The display section 24 can be an LCD (Liquid Crystal Display), for example, and displays a document creation screen of the application section 26, a printing instruction screen of the driver section 27, and a preview screen based on the edit data received via the communication section 23, for example.

For example, the preview display controlling section 25 displays an image prepared by highlighting the replaced part in the preview image onto the display section 24, based on the edit data received from the printer 10a or the server 10b, displays the possible alternatives based on the data of possible alternatives so as to allow a user to select any of them, and displays a button or the like that instructs execution of print output.

The application section 26 is a part that executes processing based on application software for creating documents to be printed.

The driver section 27 converts document data created with the application section 26 into a print job described using language that can be interpreted by the printer 10a or the server 10b (PDL (Page Description Language), such as PCL (Printing Control Language) and PS (PostScript)).

It should be noted that FIGS. 1 to 3 illustrate examples of the printing systems according to the present example and the arrangement thereof can be changed as appropriate. For example, the printer 10a is illustrated in FIG. 1 as a device at a side where preview displaying data is generated. However, the device at a side where preview displaying data is generated need only include a means for generating a preview image by analyzing the print job. For example, it may be a printer controller that instructs printing to the printer 10a, or a RIP (Raster Image Processing) controller, for example.

Next, operations of the computing device 20a (or mobile device 20b) in the above-described arrangement will be described. The CPU 21a of the computing device 20a (or mobile device 20b) executes each process illustrated in the flowcharts in FIG. 4 and FIG. 5 by developing a program stored in the ROM 21b onto the RAM 21c and executing the program.

First, as illustrated in FIG. 4, upon detecting a start instruction of an application caused by the input section 22, the control section 2I makes the application section 26 operate and starts the application (S101). Then, the application section 26 displays an operation screen of the application on the display section 24 and makes the user create document data (S103, S104). FIG. 6 illustrates an example of a document created using the application section 26.

Next, the application section 26 determines whether a print preview display has been instructed in the operation screen of the application (e.g., whether “Print Preview” is selected in a “File” pull down menu in FIG. 6) (S105). If the print preview display has not been instructed, the process returns to S102 to determine whether termination of the application is instructed (S102). If the termination of the application is instructed, this process ends.

Meanwhile, if the print preview display has been instructed, the control section 21 makes the driver section 27 operate and starts the driver (S106), the driver section 27 generates from document data a print job in a form that enables output in the printer 10a or the server 10b (S107), and sends the generated print job to the printer 10a (or server 10b) via the communication section 23 (S108).

The printer 10a (or server 10b) that received the print job executes analysis processing and drawing processing, which will be described later, and generates edit data to be used for highlighting (displaying with emphasis) the replaced part in the preview image and data of possible alternatives for allowing a user to select possible alternatives. Then, the printer 10a (or server 10b) sends the above data to the computing device 20a (or mobile device 20b).

Thereafter, as illustrated in FIG. 5, the control section 21 receives from the printer 10a (or server 10b) the edit data and the data of possible alternatives (S201), and the preview display control section 25 operates the display section 24 to display an image prepared by highlighting the replaced part in the preview image by using the edit data (S202). In addition, if needed, the preview display control section 25 displays possible alternatives using the data of possible alternatives so as to allow a user to designate any one of the possible alternatives.

FIG. 7 and FIG. 8 illustrate examples of the preview screen displayed on the display section 24. Displayed in the preview screen are a preview image 41 based on the document in FIG. 6 (refer to left-hand side of the figure) and print setting information (refer to right-hand side of the figure). The replaced part is displayed with being highlighted (displayed with emphasis) in the preview image 41 and possible alternatives are displayed such that a user can select one of the possible alternatives.

Specifically, paragraphs in the upper part in the document in FIG. 6 are portions described using a font not supported by the printer 10a (or server 10b), and the printer 10a (or server 10b) displays a preview image by replacing the font not supported with alternative font (e.g., “Arial”) supported by the printer 10a (or server 10b). At this time, as illustrated in FIG. 7, highlighting the replaced part is carried out by, for example, changing color of the object, changing color of the background of the object, adding a frame enclosing the object, or changing thickness of characters in text objects (the highlighting is expressed herein by shading to object), so that the user can identify the font replaced part 42a in the preview image 41. In addition, possible alternatives 43 (“Arial”, “Courier New” and “OCR-B” herein) are displayed in order to allow a user to select another font different from the current alternative font. If the user selects another possible alternative (Yes in S203), alternative designating data that designates the possible alternative is sent to the printer 10a (or server 10b) (S204), and preview image edit data in which the font is replaced with the designated font is acquired from the printer 10a (or server 10b) (S201), so that the font replaced part 42a is displayed with being highlighted in the preview image 41 (S202).

As illustrated in FIG. 8, two images at the lower part in the preview image 41 are portions described with a function not supported by the printer 10a (or server 10b) (3D drawing function). The printer 10a (or server 10b) replaces the drawing function with a drawing function supported by the printer 10a (or server 10b) and highlights (displays with emphasis) the function replaced part 42b (displayed herein by adding thick frame lines). In addition, possible alternatives 43 are displayed in order to allow a user to select a function different from the current alternative function. If a user selects another alternative (Yes in S203), the alternative designating data that designating the alternative is sent to the printer 10a (or server 10b) (S204), the edit data prepared by replacing a part of the preview image with the designated function is acquired from the printer 10a (or server 10b) (S201), and the function replaced part 42b in the preview image 41 is highlighted (S202).

Thereafter, if there is an instruction to execute print output as appeared in the preview image 41 (Yes in S205), execution instruction information is transmitted to the printer 10a (or server 10b) (S206). Meanwhile, if execution instruction information is received from the computing device 20a or the mobile device 20b (or receiving execution instruction information via the server 10b), the printer 10a controls the image output section 15 so as to perform print output processing.

Next, operations of the printer 10a (or server 10b) will be described. The CPU 11a of the printer 10a (or server 10b) executes respective processes illustrated in the flowcharts in FIGS. 9 to 11 by developing a program (data generation program) stored in the ROM 11b into the RAM 11c and executing the program.

First, the control section 11 receives a print job from the computing device 20a (or mobile device 20b) via the communication section 13 (S301). Next, the preview-image generating section 14 executes analysis processing for one page of the received print job to generate intermediate language (S302), and executes drawing processing for one frame after another based on the intermediate language (S303). The analysis processing and the drawing processing will be described later.

Thereafter, the preview-image generating section 14 generates a preview bitmap image for one page (S304). If there is a next page (Yes in S305), the process returns to S302 to repeat the same processing. Meanwhile, if the bitmap images have been generated up to the last page (No in S305), edit data for the preview image and data of possible alternatives are sent to the computing device 20a (or mobile device 20b) (S306).

Next, the analysis processing (S302) and the drawing processing (S303), which are executed in the preview-image generating section 14, will be described.

### Analysis Processing:

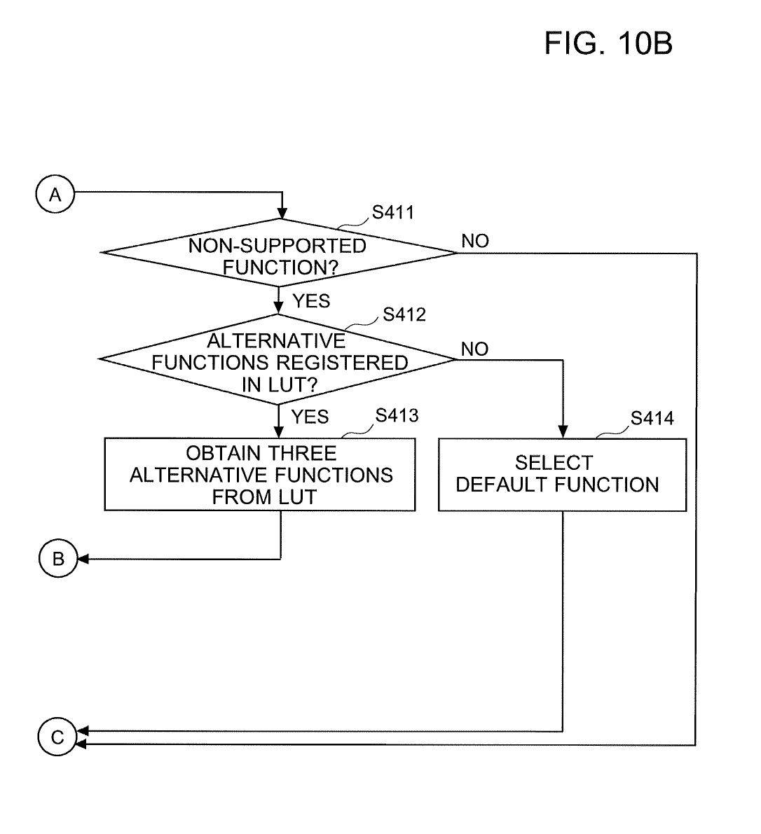

As illustrated in FIGS. 10A and 10B, first, the preview-image generating section 14 analyzes the received print job (S401) so as to determine whether the object included in one page of the print job is a text object or other object (graphic object or image object) (S402). If the object is a text object (Yes in S402), the preview-image generating section 14 determines whether the font used in the text object is a font supported by the printer 10a (or server 10b) (S403).

If the font is a font supported by the printer 10a (or server 10b), the process proceeds to S409. If the font is a font not supported by the printer 10a (or server 10b), the preview-image generating section 14 determines whether at last one possible alternative font to the determined font is registered in a LUT which has previously prepared (S404). If at least one possible alternative font is registered in the LUT, a predetermined number (arbitrary number, e.g., three) of possible alternative fonts are obtained from fonts in the LUT (S405), and a first possible alternative is selected among the selected possible alternative fonts (S407) and a second and a third possible alternatives (in the case that three possible alternatives are obtained) are registered in the storage section 16 (S408). Meanwhile, if no possible alternative font is registered in the LUT, a default font is selected as an alternative font (S406) and the process proceeds to S409.

In the LUT, it is desirable to pre-define the kind and size (font line width and font point) of the alternative font such that a preview image in which object fonts have been replaced with the alternative font fits within one page by taking into consideration proportional fonts (variable width fonts) and monospace fonts (equal-width fonts), and bold fonts and thin fonts, or the like. In particular, by maintaining the font size, it is possible to prevent in advance problems caused by font replacement, such as misalignment and a preview image extending in more than one page. In addition, although any font can be defined as a default font, the font may not be replaced with a default font. That is, there may be no drawing (blank characters are used) at the replaced part.

Meanwhile, if the object included in the page is not a text object (No in S402), the preview-image generating section 14 determines whether the object is drawn with a function not supported by the printer 10a (or server 10b) (S411). If the object is drawn with a function supported by the printer 10a (or server 10b), the process proceeds to S409. If it is drawn with a function not supported by the printer 10a (or server 10b), the preview-image generating section 14 determines whether or not at least one possible alternative to the function is registered in the LUT (S412). If at least one possible alternative function is registered in the LUT, a predetermined number (arbitrary number, e.g., three) of possible alternative functions are obtained from the LUT (S413), and a first possible alternative is selected from the selected possible alternative functions (S407) and a second and a third possible alternatives (in the case that three possible alternatives are obtained) are registered in the storage section 16 (S408). Meanwhile, if no possible alternative function is registered in the LUT, a default function is selected (S414) and the process proceeds to S409. It should be noted that it is desirable to define possible alternative functions and a default function similarly to fonts.

Next, intermediate language is created using the first possible alternative obtained in S407 (S409) and data in the created intermediate language is saved in the memory. Then, it is determined whether the analysis processing for one page is completed (S410). If the analysis for one page is not completed, the process returns to S402 to repeat the same processing for the next object.

### Drawing Processing:

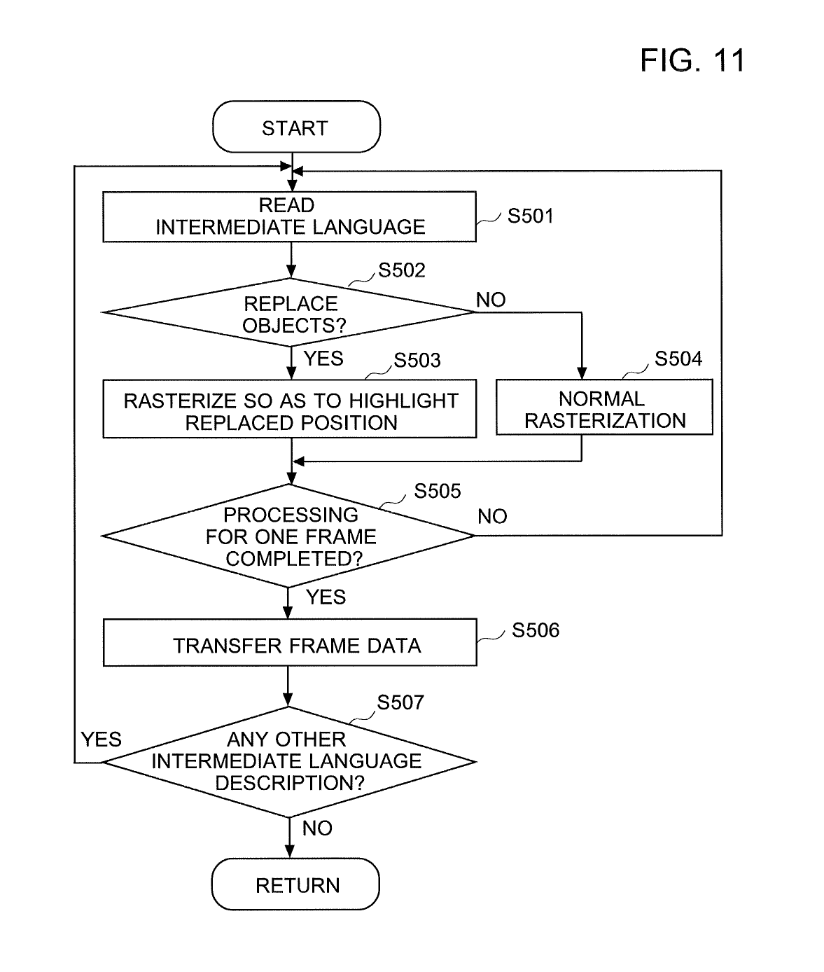

As illustrated in FIG. 11, first, the preview-image generating section 14 reads out from the memory the intermediate language data generated by the analysis processing (S501). Next, the preview-image generating section 14 determines whether to execute replacing processing for the object (S502). If the object is to be replaced with an alternative, the preview-image generating section 14 executes rasterizing processing so as to highlight the replaced part in the preview image (S503). If the object is not to be replaced with an alternative, the preview-image generating section 14 executes normal rasterizing processing (S504). Such processing is repeated for one frame. When processing for one frame is completed (Yes in S505), frame data is evacuated by transferring it to the memory (S506). Then, the preview-image generating section 14 determines whether the intermediate language remains (S507). If the intermediate language remains, the process returns to S501 to repeat the similar processing.

As described above, the present example performs processing to, in the case where there is an object having a property (font or function) not supported by the apparatus in a page when generating a preview image, obtain at least one possible alternative as a property supported by the apparatus, and generate edit data to be used for highlighting a replaced part in the preview image in which the object having the property not supported by the apparatus is replaced with the possible alternative at the replaced part. Thereby, it is possible for a user to recognize the replaced part easily, and thus it is possible for the user to determine whether or not to execute the printing job appropriately. In addition, by generating data of possible alternatives which allow a user to designate one of the obtained possible alternatives, it is possible for a user to select a desired possible alternative among the possible alternatives, and thus the user can obtain a desired printing result.

It should be noted that the present invention should not be limited to the above embodiments and examples. The arrangements of systems and devices and the method for generating preview displaying data may be modified as appropriate within the spirit of the present invention.

For example, although “font” and “function” were exemplified as properties in the above-described embodiments and examples, the property is not limited to them. In addition, although “Arial”, “Courier New” and “OCR-B” were exemplified as fonts and “3D drawing function” was exemplified as a function, neither the font nor the function is limited to them. In addition, although methods that change the object color and the background color, add a frame surrounding the object and change thickness of the characters in the text object were exemplified as methods for highlighting the replaced part in the preview image, they are is not limited to them.

In addition, although “edit data” was described as image data provided by editing a preview image such that the replaced part in the preview image is highlighted in the above-described embodiments and examples, the edit data should not be limited to that as far as the edit data is data to be used for highlighting the replaced part in the preview image. For example, the edit data may be partial data to be used for editing the preview image such that the printer 10a or the server 10b sends the preview image data and the edit data to the computing device 20a or the mobile device 20b and the computing device 20a or the mobile device 20b highlights the replaced part in the preview image using the edit data upon displaying the preview image.

In addition, although cases where the preview display for printing is performed were described in the above-described embodiment, the present invention can be applied to cases where the preview display is performed, upon transmitting predetermined pages in a document via facsimile, for confirming the contents in the pages.

1. A data generation apparatus comprising:
a communication section configured to communicate with a print instructing apparatus which can output a print job of a document; and
a preview-image generating section configured to
analyze a print job received by the communication section and
generate a preview image showing each page of the document, the each page reflecting print settings,
wherein the preview-image generating section is further configured to
determine whether or not an object having a property not supported by the data generation apparatus exists in each page of the document,
in response to determining that the object exists, obtain at least one possible alternative to the property of the object, each of the least one possible alternative being supported by the data generation apparatus,
generate edit data to be used for highlighting a replaced part in the preview image in which the property of the object is replaced with the at least one possible alternative at the replaced part, and
output the edit data to the print instructing apparatus so as to allow a user to recognize the replaced part.

2. The data generation apparatus of claim 1,
wherein the preview-image generating section is configured to
obtain a plurality of possible alternatives to the property of the object, each of the possible alternatives being supported by the data generation apparatus, and
output the possible alternatives to the print instructing apparatus so as to allow a user to designate one of the possible alternatives on the print instructing apparatus.

3. The data generation apparatus of claim 2,
wherein the preview-image generating section is configured to
in response to receiving information designating the one of the possible alternatives from the print instructing apparatus through the commutation section, generate the edit data to be used for highlighting the replaced part in the preview image in which the property of the object is replaced with the one of possible alternatives designated by the information at the replaced part, and
output the edit data to the print instructing apparatus.

4. The data generation apparatus of claim 1,
wherein the property is at least one of font and function.

5. The data generation apparatus of claim 4,
wherein the preview-image generating section is configured to
on replacing font of the object with alternative font, set a size of the alternative font so that the preview image to be obtained after the font of the object is replaced with the alternative font fits into one page.

6. The data generation apparatus of claim 1,
wherein the preview-image generating section is configured to carry out, for highlighting the replaced part in the preview image, at least one of:
changing color of an object in the replaced part,
adding a frame enclosing the object in the replaced part,
changing color of a background of the object in the replaced part, and
changing thickness of characters in the object in the replaced part.

7. A non-transitory computer-readable storage medium storing a data generation program to be executed in a processing apparatus communicably connected with a print instructing apparatus which can output a print job of a document, the data generation program, when being executed by a processor of the processing apparatus, causing the processor to perform processes comprising:
analyzing the print job; and
generating a preview image showing each page of the document, the each page reflecting print settings,
wherein the analyzing the print job includes
determining whether or not an object having a property not supported by the processing apparatus exists in each page of the document, and
in response to determining that the object exists, obtaining at least one possible alternative to the property of the object, each of the least one possible alternative being supported by the processing apparatus, and
the generating the preview image includes
generating edit data to be used for highlighting a replaced part in the preview image in which the property of the object is replaced with the at least one possible alternative at the replaced part, and
outputting the edit data to the print instructing apparatus so as to allow a user to recognize the replaced part.

8. The non-transitory computer-readable storage medium of claim 7,
wherein the analyzing the print job includes
obtaining a plurality of possible alternatives to the property of the object, each of the possible alternatives being supported by the processing apparatus, and
outputting the possible alternatives to the print instructing apparatus so as to allow a user to designate one of the possible alternatives on the print instructing apparatus.

9. The non-transitory computer-readable storage medium of claim 8,
wherein the generating the preview image includes,
in response to receiving information designating the one of the possible alternatives from the print instructing apparatus, generating the edit data to be used for highlighting the replaced part in the preview image in which the property of the object is replaced with the one of possible alternatives designated by the information at the replaced part, and
outputting the edit data to the print instructing apparatus.

10. The non-transitory computer-readable storage medium of claim 7,
wherein the property is at least one of font and function.

11. The non-transitory computer-readable storage medium of claim 10,
wherein the generating the preview image includes,
on replacing font of the object with alternative font, setting a size of the alternative font so that the preview image to be obtained after the font of the object is replaced with the alternative font fits into one page.

12. The non-transitory computer-readable storage medium of claim 7,
wherein the generating the preview image includes, carrying out, for highlighting the replaced part in the preview image, at least one of:
changing color of an object in the replaced part,
adding a frame enclosing the object in the replaced part,
changing color of a background of the object in the replaced part, and
changing thickness of characters in the object in the replaced part.

13. A data generation method of a printing system including a print instructing apparatus which can output a print job of a document and a processing apparatus which can process the print job, the print instructing apparatus and the processing apparatus being connected through a communication network,
the data generation method comprising:
sending a print job from the print instructing apparatus to the processing apparatus;
receiving and analyzing the print job by the processing apparatus;
generating a preview image showing each page of the document, by the processing apparatus, the each page reflecting print settings; and
displaying the preview image by the print instructing apparatus,
wherein the analyzing the print job includes
determining, by the processing apparatus, whether or not an object having a property not supported by the processing apparatus exists in each page of the document, and
in response to determining that the object exists, obtaining, by the processing apparatus, at least one possible alternative to the property of the object, each of the least one possible alternative being supported by the processing apparatus,
the generating the preview image includes
generating, by the processing apparatus, edit data to be used for highlighting a replaced part in the preview image in which the property of the object is replaced with the at least one possible alternative at the replaced part, and
outputting the edit data from the processing apparatus to the print instructing apparatus, and
the displaying the preview image includes
displaying the preview image by the print instructing apparatus by using the edit data so as to allow a user to recognize the replaced part.

14. The data generation method of claim 13,
wherein the analyzing the print job includes
obtaining, by the processing apparatus, a plurality of possible alternatives to the property of the object, each of the possible alternatives being supported by the processing apparatus, and
outputting the possible alternatives from the processing apparatus to the print instructing apparatus, and
the displaying the preview image includes
displaying the possible alternatives by the print instructing apparatus so as to allow a user to designate one of the possible alternatives.

15. The data generation method of claim 14,
wherein the generating the preview image includes,
in response to receiving information designating the one of the possible alternatives from the print instructing apparatus, generating, by the processing apparatus, the edit data to be used for highlighting the replaced part in the preview image in which the property of the object is replaced with the one of possible alternatives designated by the information at the replaced part, and
outputting the edit data from the processing apparatus to the print instructing apparatus.

16. The data generation method of claim 13,
wherein the property is at least one of font and function.

17. The data generation method of claim 16,
wherein the generating the preview image includes,
on replacing font of the object with alternative font, setting a size of the alternative font so that the preview image to be obtained after the font of the object is replaced with the alternative font fits into one page.

18. The data generation method of claim 13,
wherein the generating the preview image includes, carrying out by the processing apparatus, for highlighting the replaced part in the preview image, at least one of:
changing color of an object in the replaced part,
adding a frame enclosing the object in the replaced part,
changing color of a background of the object in the replaced part, and
changing thickness characters in the object in the replaced part.
